(19) United States
(12) Patent Application Publication
(10) Pub. No.: US 2024/0147471 A1
(43) Pub. Date: May 2, 2024

(54) ENHANCED INTRA-USER EQUIPMENT PRIORITIZATION FOR UPLINK TRANSMISSIONS

(71) Applicant: INTEL CORPORATION, Santa Clara, CA (US)

(72) Inventors: Toufiqul ISLAM, Milpitas, CA (US); Debdeep CHATTERJEE, San Jose, CA (US)

(21) Appl. No.: 18/549,316

(22) PCT Filed: Apr. 6, 2022
(86) PCT No.: PCT/US2022/023741

§ 371 Date: Sep. 6, 2023

Related U.S. Application Data
(60) Provisional application No. 63/171,537, filed on Apr. 6, 2021.

(51) Int. Cl. H04W 72/1268; H04W 72/21; H04W 72/232; H04W 72/51; H04W 72/566

(52) U.S. Cl. CPC H04W 72/1268; H04W 72/21; H04W 72/232; H04W 72/51; H04W 72/566

(57) ABSTRACT

This disclosure describes systems, methods, and devices related to avoiding overlapping uplink transmissions. A user equipment (UE) device may identify a first physical downlink control channel (PDCCH) transmission and a second PDCCH transmission received from a 5th Generation node (gNB) device; determine, based on the first PDCCH transmission, that the UE device is to transmit a first physical uplink control channel transmission to the gNB device; determine, based on the second PDCCH transmission, that the UE device is to transmit a second physical uplink control channel transmission to the gNB device at a time overlapping the first physical uplink control channel transmission; set a time period after the second PDCCH transmission and during which the UE device is to refrain from transmitting the second physical uplink control channel transmission to the gNB device; and transmit the second physical uplink control channel transmission to the gNB device after the time period.

### CROSS-REFERENCE TO RELATED PATENT APPLICATION(S)

This application claims the benefit of U.S. Provisional Application No. 63/171,537, filed Apr. 6, 2021, the disclosure of which is incorporated by reference as set forth in full.

### TECHNICAL FIELD

This disclosure generally relates to systems and methods for wireless communications and, more particularly, to user equipment device prioritization for 5^{th} Generation (5G) communications.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example process for avoiding overlapping uplink transmissions, according to some example embodiments of the present disclosure.

FIG. 2 is flow diagram of illustrative process for avoiding overlapping uplink transmissions, in accordance with one or more example embodiments of the present disclosure.

FIG. 3 illustrates a network, in accordance with one or more example embodiments of the present disclosure.

FIG. 4 schematically illustrates a wireless network, in accordance with one or more example embodiments of the present disclosure.

FIG. 5 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may perform measurements as defined by technical standards. For cellular telecommunications, the 3^{rd} Generation Partnership Program (3GPP) define communication techniques, including for managing transmissions between user equipment (UE) devices and gNB and other 5^{th} Generation (5G) network devices.

In particular, Release 17 of the 3GPP standards may allow for overlapping physical uplink shared control channel (PUSCH) and physical uplink control channel (PUCCH) transmissions. Release 16 of the 3GPP standards allows for low- and high-priority transmissions. A UE may be scheduled for a lower priority uplink transmission (e.g., to a gNB), and a higher priority transmission may be needed, so the gNB may schedule the higher priority transmission as soon as possible, resulting in an overlap with the lower priority uplink transmission from the UE. Release 16 defines procedures for a UE to drop ongoing transmissions to make a higher priority transmission.

For a UE to drop a low-priority transmission in favor of a high-priority transmission, some rules need to be in place, such as a timeline (e.g., start and stop time) for the high-priority transmission. The timeline is important to avoid any overlap with the high-priority transmission so that no information in the high-priority transmission is missed. For example, it may be important to define the timing of when the downlink control information (DCI) needs to be received by the UE before the high-priority transmission, as the DCI may trigger the high-priority transmission.

The present disclosure defines methods for defining the processing timelines considering PUSCH-PUCCH, PUCCH-PUCCH, and PUSCH-PUSCH time-overlaps when each of a pair of overlapping channels have different physical layer (PHY) priorities.

When a high-priority (HP) uplink (UL) transmission overlaps with low-priority (LP) UL transmission, the Release 16 (Rel-16) specification allows a UE to prioritize and transmit the HP UL transmission and drop the LP UL transmission. This procedure in Rel-16 only supports collision of PUCCH and PUSCH transmission. Release 17 (Rel-17) is considering overlap of PUSCH and PUSCH transmissions.

For PHY prioritization, it is essential that a UE expects that HP UL transmission would not start before the first overlapping symbols. Therefore, it is important to accurately identify the timeline to determine when HP UL transmission could start, and it is even more critical in real deployment so that HP UL transmission reliability is protected.

In one or more embodiments, when a UE determines overlapping for PUCCH and/or PUSCH transmissions of different priority indexes, including repetitions if any, the UE first resolves the overlapping for PUCCH and/or PUSCH transmissions of smaller priority index as described in Clauses 9.2.5 and 9.2.6 of TS 38.213 (e.g., identifying overlap and using multiplexing). Then, (1) if a transmission of a first PUCCH of larger priority index scheduled by a DCI format in a PDCCH reception would overlap in time with a repetition of a transmission of a second PUSCH or a second PUCCH of smaller priority index, the UE cancels the repetition of a transmission of the second PUSCH or the second PUCCH before the first symbol that would overlap with the first PUCCH transmission; (2) if a transmission of a first PUSCH of larger priority index scheduled by a DCI format in a PDCCH reception would overlap in time with a repetition of the transmission of a second PUCCH of smaller priority index, the UE cancels the repetition of the transmission of the second PUCCH before the first symbol that would overlap with the first PUSCH transmission. In this manner, there may be a two-step process to identify the timeline for the high-priority transmission: (1) Resolving the overlap of a low-priority transmission, and (2) the UE determines whether the overlap includes a high-priority transmission.

In one or more embodiments, the overlapping is applicable before or after resolving overlapping among channels of larger priority index, if any, as described in Clauses 9.2.5 and 9.2.6 of TS 38.213. The UE may expect that the transmission of the first PUCCH or the first PUSCH, respectively, would not start before T″_{proc,2} after a last symbol of the corresponding PDCCH reception, where T″_{proc,2} is obtained from T_{proc,2}, which is the PUSCH preparation time for a corresponding UE processing capability assuming, in one example, d_{2,1}=d₁ (demodulation reference signal symbols included for channel estimation) [Section 6, TS 38.214]. The definition of T_{proc,2} is also repeated below as referenced from Section 6, TS 38.214, based on μ and N₂ as subsequently defined below, and d₁ (an additional delay) is determined by a reported UE capability. N₂ is based on μ, where μ corresponds to one of (μ_{DL}, μ_{UL}) resulting with the largest T_{proc,2}, where the μ_{DL} corresponds to the subcarrier spacing of the downlink with which the PDCCH carrying the DCI scheduling the PUSCH was transmitted and μ_{UL} corresponds to the subcarrier spacing of the uplink channel with which the PUSCH is to be transmitted.

In one or more embodiments, if a UE is scheduled by a DCI format in a first PDCCH reception to transmit a first PUCCH or a first PUSCH of larger priority index that overlaps with a second PUCCH or a second PUSCH transmission of smaller priority index that, if any, is scheduled by a DCI format in a second PDCCH, T_{proc,2} is based on a value of μ corresponding to the smallest SCS configuration of the first PDCCH, the second PDCCHs, the first PUCCH or the first PUSCH, and the second PUCCHs or the second PUSCHs. If the overlapping group includes the first PUCCH: (1) If processingType2Enabled of PDSCH-ServingCellConfig is set to enable for the serving cell where the UE receives the first PDCCH and for all serving cells where the UE receives the PDSCHs corresponding to the second PUCCHs, and if processingType2Enabled of PUSCH-ServingCellConfig is set to enable for the serving cells with the second PUSCHs, N₂ is 5 for μ=0, 5.5 for μ=1 and 11 for μ=2, (2) else, N₂ is 10 for μ=0, 12 for μ=1, 23 for μ=2, and 36 for μ=3. If the overlapping group includes the first PUSCH: (1) If processingType2Enabled of PUSCH-ServingCellConfig is set to enable for the serving cells with the first PUSCH and the second PUSCHs and if processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2; (2) else, N₂ is 10 for μ=0, 12 for μ=1, 23 for μ=2, and 36 for μ=3.

In one or more embodiments, d_{2,1}=d₁˜2^{-μ}^{_{UL}}/2^{-μ}, where d₁ is determined by a reported UE capability, μ being the smallest SCS configuration between the SCS configuration of the PDCCH and the smallest SCS configuration μ_{UL} provided in scs-SpecificCarrierList of FrequencyInfoUL or FrequencyInfoUL-SIB (cf. TS 38.331).

In one or more embodiments, when a UE determines overlapping for PUCCH and/or PUSCH transmissions of different priority indexes, including repetitions if any, the UE first resolves the overlapping for PUCCH and/or PUSCH transmissions of smaller priority index as described in Clauses 9.2.5 and 9.2.6 of TS 38.213. Then, (1) if a transmission of a first PUCCH of larger priority index scheduled by a DCI format in a PDCCH reception would overlap in time with a repetition of a transmission of a second PUSCH or a second PUCCH of smaller priority index, the UE cancels the repetition of a transmission of the second PUSCH or the second PUCCH before the first symbol that would overlap with the first PUCCH transmission; or (2) if a transmission of a first PUSCH of larger priority index scheduled by a DCI format in a PDCCH reception would overlap in time with a repetition of the transmission of a second PUCCH of smaller priority index, the UE cancels the repetition of the transmission of the second PUCCH before the first symbol that would overlap with the first PUSCH transmission. The overlapping is applicable before or after resolving overlapping among channels of larger priority index, if any, as described in Clauses 9.2.5 and 9.2.6 of TS 38.213. The UE may expect that the transmission of the first PUCCH or the first PUSCH, respectively, would not start before T″_{proc,2} after a last symbol of the corresponding PDCCH reception, where T″_{proc,2} is obtained from T_{proc,2}, which is the PUSCH preparation time for a corresponding UE processing capability assuming, in one example, d_{2,1}=d₁ [Section 6, TS 38.214] (Definition of T_{proc,2} is also repeated herein as reference from Section 6, TS 38.214), based on μ and N₂ as subsequently defined below, and d₁ is determined by a reported UE capability.

In one or more embodiments, if a UE is scheduled by a DCI format in a first PDCCH reception to transmit a first PUCCH or a first PUSCH of larger priority index that overlaps with a second PUCCH or a second PUSCH transmission of smaller priority index that, if any, is scheduled by a DCI format in a second PDCCH: (1) T_{proc,2} is based on a value of μ corresponding to the smallest SCS configuration of the first PDCCH, the second PDCCHs, the first PUCCH or the first PUSCH, and the second PUCCHs or the second PUSCHs. If the overlapping group includes the first PUCCH: (a) if processingType2Enabled of PDSCH-ServingCellConfig is set to enable for the serving cell where the UE receives the first PDCCH and for all serving cells where the UE receives the PDSCHs corresponding to the second PUCCHs, and if processingType2Enabled of PUSCH-ServingCellConfig is set to enable for the serving cells with the second PUSCHs, N₂ is 5 for μ=0, 5.5 for μ=1 and 11 for μ=2; (b) else, N₂ is 10 for μ=0, 12 for μ=1, 23 for μ=2, and 36 for μ=3. (2) If the overlapping group includes the first PUSCH: (a) if processingType2Enabled of PUSCH-ServingCellConfig is set to enable for the serving cells with the first PUSCH and the second PUSCHs and if processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2; (b) else, N₂ is 10 for μ=0, 12 for μ=1, 23 for μ=2, and 36 for μ=3.

In one or more embodiments, d_{2,1}=d₁·2^{-μ}^{_{UL}}/2^{-μ}i, where d₁ is determined by a reported UE capability, μ being the smallest SCS configuration between the SCS configuration of the PDCCH and the smallest SCS configuration μ_{UL} provided in scs-SpecificCarrierList of FrequencyInfoUL or FrequencyInfoUL-SIB (cf. TS 38.331).

In one or more embodiments, when a UE determines overlapping for PUCCH and/or PUSCH transmissions of different priority indexes other than PUCCH transmissions with SL HARQ-ACK reports, including repetitions if any, the UE first resolves the overlapping for PUCCH and/or PUSCH transmissions of smaller priority index as described in Clauses 9.2.5 and 9.2.6 of TS 38.213. Then, (1) if a transmission of a first PUCCH of larger priority index scheduled by a DCI format in a PDCCH reception would overlap in time with a repetition of a transmission of a second PUSCH or a second PUCCH of smaller priority index, the UE cancels the repetition of a transmission of the second PUSCH or the second PUCCH before the first symbol that would overlap with the first PUCCH transmission; or (2) if a transmission of a first PUSCH of larger priority index scheduled by a DCI format in a PDCCH reception would overlap in time with a repetition of the transmission of a second PUCCH of smaller priority index, the UE cancels the repetition of the transmission of the second PUCCH before the first symbol that would overlap with the first PUSCH transmission. The overlapping is applicable before or after resolving overlapping among channels of larger priority index, if any, as described in Clauses 9.2.5 and 9.2.6 of TS 38.213. Any remaining PUCCH and/or PUSCH transmission after overlapping resolution is subjected to the limitations for UE transmission as described in Clause 11.1 of TS 38.213. The UE may expect that the transmission of the first PUCCH or the first PUSCH, respectively, would not start before T_{proc,2}+d₁(2048+144)·κ2^{-μ}·T_{C} after a last symbol of the corresponding PDCCH reception. T_{proc,2} is the PUSCH preparation time for a corresponding UE processing capability assuming d_{2,1}=0 [6, TS 38.214] (Definition of T_{proc,2} is also repeated herein), based on μ and N₂ which are defined above, and d₁ is determined by a reported UE capability. κ and T_{C} are defined in [6, 38.214], and can be found below in the definition of T_{proc,2}.

In one or more embodiments, when a UE determines overlapping for PUSCH transmissions of different priority indexes, including repetitions if any, the UE first resolves the overlapping for PUSCH transmissions of smaller priority index as described in Clauses 9.2.5 and 9.2.6 of TS 38.213. Then, in a first scenario, if a transmission of a first PUSCH of larger priority index scheduled by a DCI format in a PDCCH reception would overlap in time with a repetition of a transmission of a second PUSCH of smaller priority index that is not scheduled by a DCI format or based on configured-grant, the UE cancels the repetition of a transmission of the second PUSCH before the first symbol that would overlap with the first PUCCH transmission. In a second scenario, if a transmission or a repetition of transmission a first PUSCH of larger priority index is not scheduled by a DCI format would overlap in time with a transmission of a second PUSCH of smaller priority index that is scheduled by a DCI format in a PDCCH reception, the UE cancels the transmission of the second PUSCH before the first symbol that would overlap with the first PUSCH transmission. Here, the overlapping is applicable before or after resolving overlapping among channels of larger priority index, if any, as described in Clauses 9.2.5 and 9.2.6 TS 38.213. The UE may expect that the transmission of the first PUSCH according to first scenario, would not start before T″_{proc,2} after a last symbol of the corresponding PDCCH reception, where T″_{proc,2} is obtained from T_{proc,2}, which is the PUSCH preparation time for a corresponding UE processing capability assuming, in one example, d_{2,1}=d₁ [Section 6, TS 38.214] (Definition of T_{proc,2} is also repeated herein), based on μ and N₂ as subsequently defined below, and d₁ is determined by a reported UE capability.

In one or more embodiments, if a UE is scheduled by a DCI format in a first PDCCH reception to transmit a first PUSCH of larger priority index that overlaps with a second PUSCH transmission of smaller priority index that is not scheduled by a DCI format, i.e., first scenario, T_{proc,2} is based on a value of μ corresponding to the smallest SCS configuration of the first PDCCH, the first PUSCH, and the second PUSCH. If processingType2Enabled of PUSCH-ServingCellConfig is set to enable for the serving cells with the first PUSCH and the second PUSCHs, N₂ is 5 for μ=0, 5.5 for μ=1 and 11 for μ=2. Else, N₂ is 10 for μ=0, 12 for μ=1, 23 for μ=2, and 36 for μ=3.

In one or more embodiments, d_{2,1}=d₁·2^{-μ}^{_{UL}}/2^{-μ}, where d₁ is determined by a reported UE capability, μ being the smallest SCS configuration between the SCS configuration of the PDCCH and the smallest SCS configuration 82 _{UL} provided in scs-SpecificCarrierList of FrequencyInfoUL or FrequencyInfoUL-SIB (cf. v 16.1 TS 38.331).

In one or more embodiments, T″_{proc,2} may be defined as Equation (1): T″_{proc,2}=T_{proc,2}+d₁(2048+144)·κ2^{-μ}·T_{C}. Here, T_{proc,2} is the PUSCH preparation time for a corresponding UE processing capability assuming d_{2,1}=0 [Section 6, TS 38.214] (Definition of T_{proc,2} is also repeated herein), based on μ and N₂ which are defined above, and d₁ is determined by a reported UE capability. K2 is the time slot offset for transmitting the PUSCH. The size of various fields in the time domain is expressed in time units

$${T}_{C} = \frac{1}{( Δ {f}_{max} \cdot {N}_{f} )}$$

where Δfₘₐₓ=480·10³ Hz and N_{f}=4096. The constant

$$K = \frac{{T}_{s}}{T c} = 64$$

where

$${T}_{s} = \frac{1}{( Δ {f}_{ref} \cdot {N}_{f , ref}} ) , Δ {f}_{ref} = 15 : {10}^{3} Hz$$

### and N_{f,ref}=2048.

In one or more embodiments, if the first uplink symbol in the PUSCH allocation for a transport block, including the DM-RS (demodulation reference signal), as defined by the slot offset K2 and the start S and length L of the PUSCH allocation indicated by “Time domain resource assignment” of the scheduling DCI and including the effect of the timing advance, is no earlier than at symbol L2, where L2 is defined as the next uplink symbol with its CP starting T_{proc,2}=max((N₂+d_{2,1}+d₂)(2048+144)(K2^{-μ}·T_{C}+Tₑₓₜ+T_{switch}, d_{2,2}) after the end of the reception of the last symbol of the PDCCH carrying the DCI scheduling the PUSCH, then the UE shall transmit the transport block. In this manner, T″_{proc,2} of Equation (1) is at least as long as T_{proc,2}, meaning that the cancelation time during which the UE will not transmit the higher priority uplink transmission after receiving a downlink transmission (e.g., triggering the uplink transmission) is at least as long as the time when the first overlapping symbols would have occurred if the UE were to transmit the overlapping lower and higher priority uplink transmissions.

In one or more embodiments, N2 is based on μ of Table 6.4-1 and Table 6.4-2 below for UE processing capability 1 and 2 respectively, where μ corresponds to the one of (μDL, μUL) resulting with the largest T_{proc,2}, where the μ_{DL} corresponds to the subcarrier spacing of the downlink with which the PDCCH carrying the DCI scheduling the PUSCH was transmitted and μ_{UL} corresponds to the subcarrier spacing of the uplink channel with which the PUSCH is to be transmitted, and κ is defined in clause 4.1 of [Section 4, TS 38.211]. For operation with shared spectrum channel access, Tₑₓₜ is calculated according to [4, TS 38.211], otherwise Tₑₓₜ=0. If the first symbol of the PUSCH allocation consists of DM-RS only, then d_{2,1}=0, otherwise d_{2,1}=1. If the UE is configured with multiple active component carriers, the first uplink symbol in the PUSCH allocation further includes the effect of timing difference between component carriers as given in [11, TS 38.133]. If the scheduling DCI triggered a switch of BWP, d_{2,1} equals to the switching time as defined in [11, TS 38.133], otherwise d_{2,2}=0. If a PUSCH of a larger priority index would overlap with PUCCH of a smaller priority index, d₂ for the PUSCH of a larger priority is set as reported by the UE; otherwise d₂=0. For a UE that supports capability 2 on a given cell, the processing time according to UE processing capability 2 is applied if the high layer parameter processingType2Enabled in PUSCH-ServingCellConfig is configured for the cell and set to “enable.” If the PUSCH indicated by the DCI is overlapping with one or more PUCCH channels, then the transport block is multiplexed following the procedure in clause 9.2.5 of [6, TS 38.213], otherwise the transport block is transmitted on the PUSCH indicated by the DCI. If uplink switching gap is triggered as defined in clause 6.1.6, T_{switch} equals to the switching gap duration and for the UE configured with higher layer parameter uplinkTxSwitchingOption set to ‘dualUL’ for uplink carrier aggregation μUL=min(μUL,carrier1, μUL,carrier2), otherwise T_{switch}=0. Otherwise the UE may ignore the scheduling DCI. The value of T_{proc,2} is used both in the case of normal and extended cyclic prefix.

In one or more embodiments, d_{2,1} represents reference symbols included in a PUSCH/PUCCH transmission for channel estimation purposes. If the reference symbol(s) are near the end of the PUSCH/PUCCH transmission, the gNB as the receiving device may need to wait for the reference symbols to process the PUSCH/PUCCH transmission. Therefore, more reference symbols in the PUSCH/PUCCH transmission requires more processing time for the gNB. This is why N₂+d_{2,1}+d₂ is used in the equation for T_{proc,2}. N₂ represents the minimum symbols needed. This is why if the first symbol of the PUSCH allocation includes a demodulation reference symbol, then d_{2,1}=0, otherwise d_{2,1}=1 to allow for more time to receive the signal. Therefore, d_{2,1} takes into account whether there are more demodulation reference symbols in the uplink signal. In Equation (1), d_{2,1} is repurposed as d₁, which is determined as a reported UE capability.

TABLE 6.4-1
PUSCH preparation time for PUSCH timing capability 1

| | PUSCH preparation time N₂ |
|---|---|
| μ | [symbols] |
| 0 | 10 |
| 1 | 12 |
| 2 | 23 |
| 3 | 36 |

TABLE 6.4-2
PUSCH preparation time for PUSCH timing capability 2

| | PUSCH preparation time N₂ |
|---|---|
| μ | [symbols] |
| 0 | 5 |
| 1 | 5.5 |
| 2 | 11 for frequency range 1 |

In one or more embodiments, a UE may receive a DCI in a PDCCH for a first PUSCH having a high priority. The UE may receive a DCI in the PDCCH for a second PUCCH having a low priority. The scheduled resources of the PUSCH and of the PUCCH may overlap, so the UE may transmit the first PUSCH that does not starts before T″_{proc,2} after a last symbol of a corresponding PDCCH reception, where T″_{proc,2} is obtained from T_{proc,2}, which is the PUSCH preparation time for a corresponding UE processing capability, assuming d_{2,1}=d₁ in the definition of T_{proc,2} from Section 6 of TS 28.214, based on μ and N₂, which are a function of the numerology of one or more of the PDCCH of the first PUSCH, the first PUSCH, the second PUCCH, and d₁ is determined by a reported UE capability. The UE may drop the second PUCCH.

In one or more embodiments, T_{proc,2} may be based on a value of μ corresponding to a smallest SCS configuration of the first PDCCH, the second PDCCH, the first PUCCH, the first PUSCH, the second PUCCH, or the second PUSCH.

In one or more embodiments, the processingType2Enabled of PUSCH-ServingCellConfig is set to enable for the serving cells with the first PUSCH and the second PUSCHs, and processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2.

In one or more embodiments, the processingType2Enabled of PUSCH-ServingCellConfig is not set to enable for the serving cells with the first PUSCH and the second PUSCHs and N₂ is 10 for μ=0, 12 for μ=1, 23 for μ=2, and 36 for μ=3.

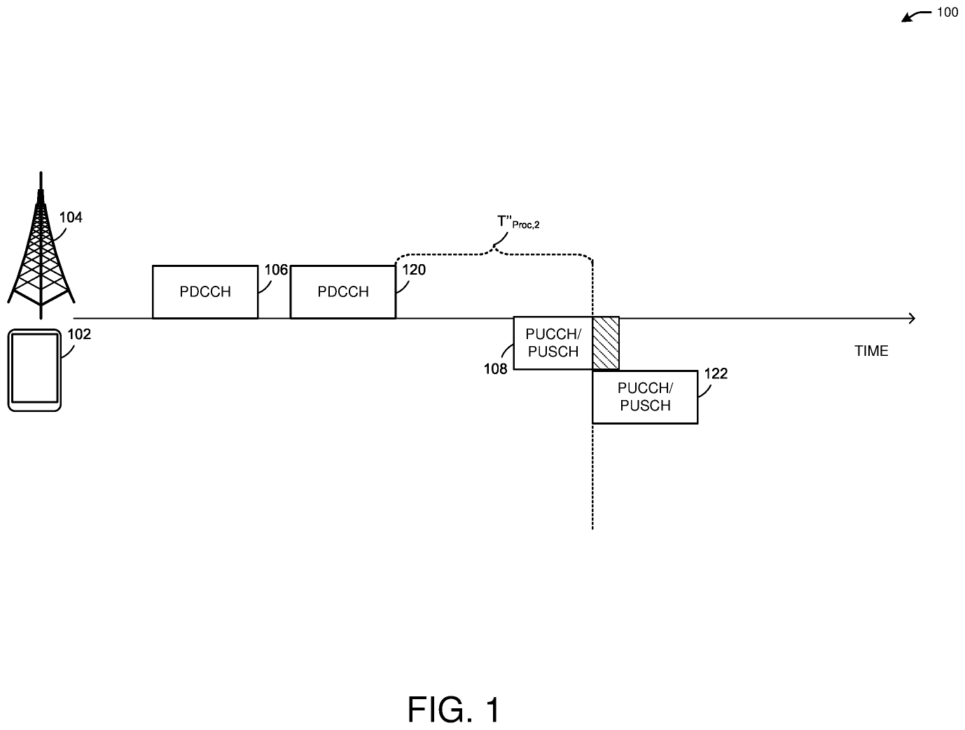

FIG. 1 is a network diagram illustrating an example process 100 for avoiding overlapping uplink transmissions, according to some example embodiments of the present disclosure.

Referring to FIG. 1, a UE device 102 may be in communication with a gNB 104. The gNB 104 may transmit a PDCCH 106 (e.g., with DCI information to trigger uplink transmissions from the UE device 102). Based on the PDCCH 106, the UE device 102 may generate a PUCCH/PUSCH 108 (e.g., physical uplink control channel transmission, either shared or not). The gNB 104 may transmit another PDCCH 120, which may trigger the UE device 102 to generate and a PUCCH/PUSCH 122 (e.g., physical uplink control channel transmission, either shared or not). The time at which the PUCCH/PUSCH 122 transmission may begin may overlap the transmission of the PUCCH/PUSCH 108.

Still referring to FIG. 1, to avoid overlapping the uplink transmissions, the UE device 102 may determine, based on the information in the PDCCH 106 and in the PDCCH 120 received from the gNB 104, respective priority indices for the PUCCH/PUSCH 108 and the PUCCH/PUSCH 122 (e.g., based on DCI in the PDCCH 106 and in the PDCCH 120). Whichever uplink transmission has the higher priority, the UE device 102 may transmit (e.g., the PUCCH/PUSCH 122), while refraining from transmitting the lower-priority PUCCH/PUSCH at the first overlapping symbol (e.g., the shaded portion of the PUCCH/PUSCH 108 as shown, beginning at the start of the PUCCH/PUSCH 122). The UE device 102 may cancel the lower priority transmission of the PUCCH/PUSCH 108 at least before the overlapping begins with the higher priority PUCCH/PUSCH 122.

Still referring to FIG. 1, the UE device 102 may set a time period (T″_{proc,2}) during which the UE device 102 is not to transmit the higher priority uplink PUCCH/PUSCH 122 to the gNB 104. The time period may begin after the PDCCH 120 has been received and processed by the UE device 102, and may depend on the time that the UE 102 would need to generate the PUCCH/PUSCH 108 or the PUCCH/PUSCH 122 (T_{proc,2}). The time period may be set using Equation (1) above, and therefore may be at least as long as T_{proc,2}, and may account for subcarrier spacing, a time slot offset, a capability of the UE device 102, and other variables.

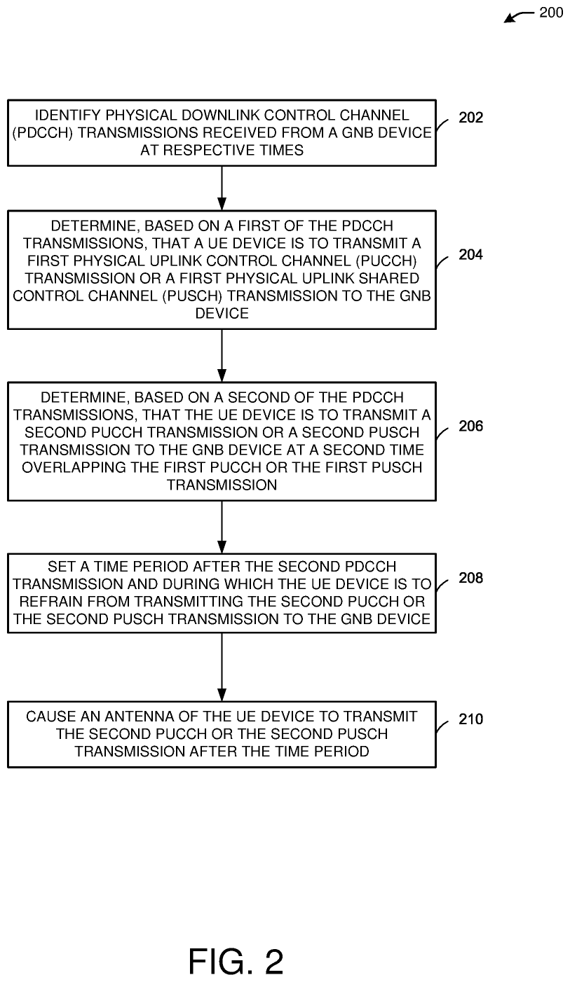

FIG. 2 is flow diagram of illustrative process 200 for avoiding overlapping uplink transmissions, in accordance with one or more example embodiments of the present disclosure.

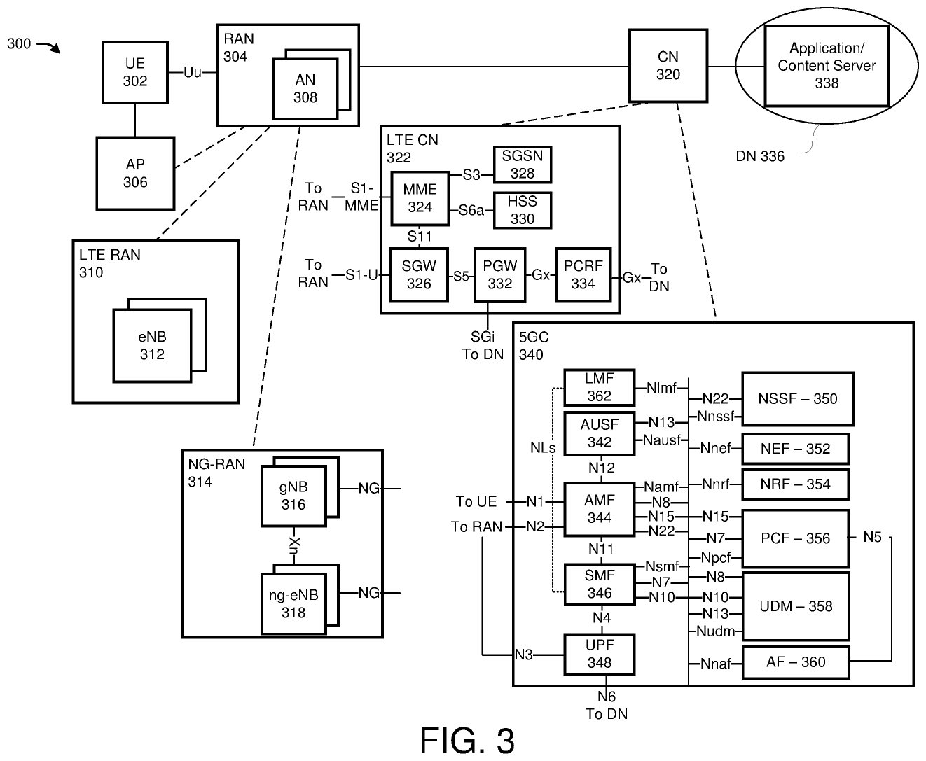

At block 202, a device (e.g., the UE device 102 of FIG. 1, the UE 302 of FIG. 3) may identify PDCCH transmissions (e.g., the PDCCH 106 and the PDCCH 120 of FIG. 1) received from a gNB (e.g., the gNB device 104 of FIG. 1, the gNB 316 or the ng-eNB 318 of FIG. 3). The PDCCH transmissions may have information (e.g., DCI) triggering multiple uplink transmissions from the device, and may indicate which uplink transmission has higher priority.

At block 204, the device may determine, based on a first PDCCH from block 202, that the UE device is to transmit a first physical uplink control transmission (e.g., the PUCCH/PUSCH 108 of FIG. 1) to the gNB.

At block 206, the device may determine, based on a second PDCCH from block 202, that the UE device is to transmit a second physical uplink control transmission (e.g., the PUCCH/PUSCH 122 of FIG. 1) to the gNB. The device may determine that the first and second uplink transmissions may at least partially overlap in time. The PDCCH transmissions may provide priority indices for the uplink transmissions.

At block 208, the device may determine a time period, after the second PDDCH transmission is received and processed, during which the device is to refrain from transmitting the higher priority uplink transmission (e.g., the second uplink transmission) to the gNB. The time period may be T″_{proc,2} determined using Equation (1) above. In this manner, the device may avoid transmitting the higher priority PUCCH or PUSCH transmission until at least after the time period T″_{proc,2}.

At block 210, after expiration of the time period, the device may transmit the second physical uplink control transmission (e.g., the higher priority PUCCH/PUSCH transmission) to the gNB (e.g., based on whichever transmission has a higher priority index). The device may refrain from transmitting the lower priority transmission to avoid overlap, either by not transmitting the lower priority transmission at all, or by stopping the lower priority transmission prior to the higher priority transmission to avoid overlap.

The examples herein are not meant to be limiting.

FIG. 3 illustrates a network 300, in accordance with one or more example embodiments of the present disclosure.

The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN 314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an S1 interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 336 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 538 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, AF 360, and LMF 362 coupled with one another over interfaces (or “reference points”) as shown. Functions of the elements of the 5GC 340 may be briefly introduced as follows.

The AUSF 342 may store data for authentication of UE 502 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the UE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 321 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, and subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3rd party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

The LMF 362 may receive measurement information (e.g., measurement reports) from the NG-RAN 314 and/or the UE 302 via the AMF 344. The LMF 362 may use the measurement information to determine device locations for indoor and/or outdoor positioning.

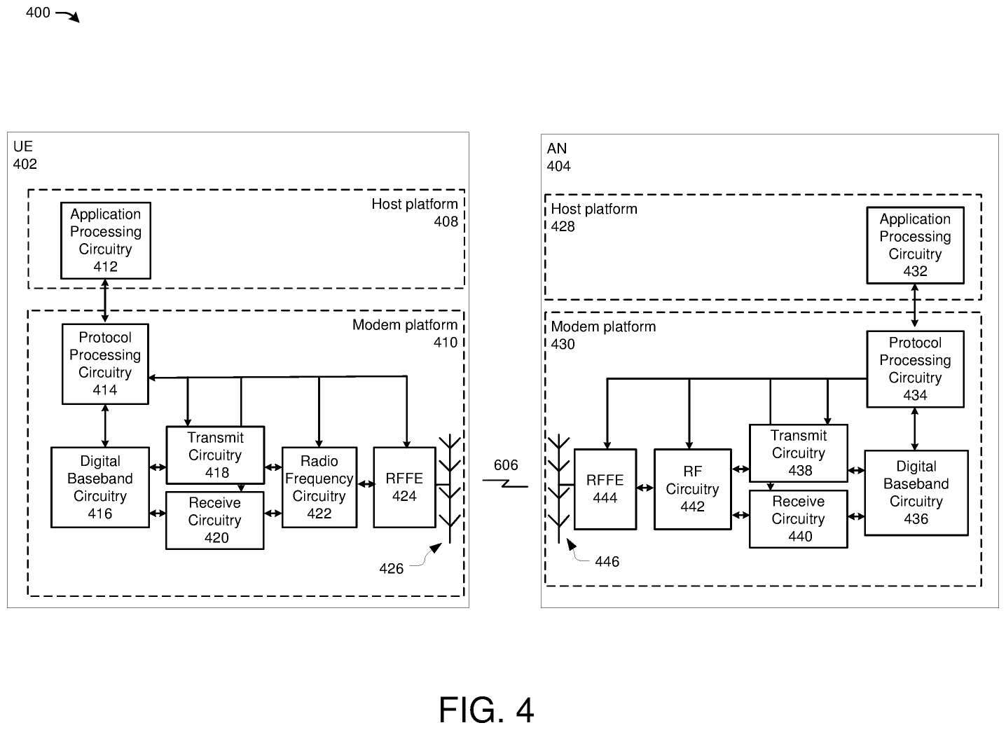

FIG. 4 schematically illustrates a wireless network 400, in accordance with one or more example embodiments of the present disclosure.

The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHz frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

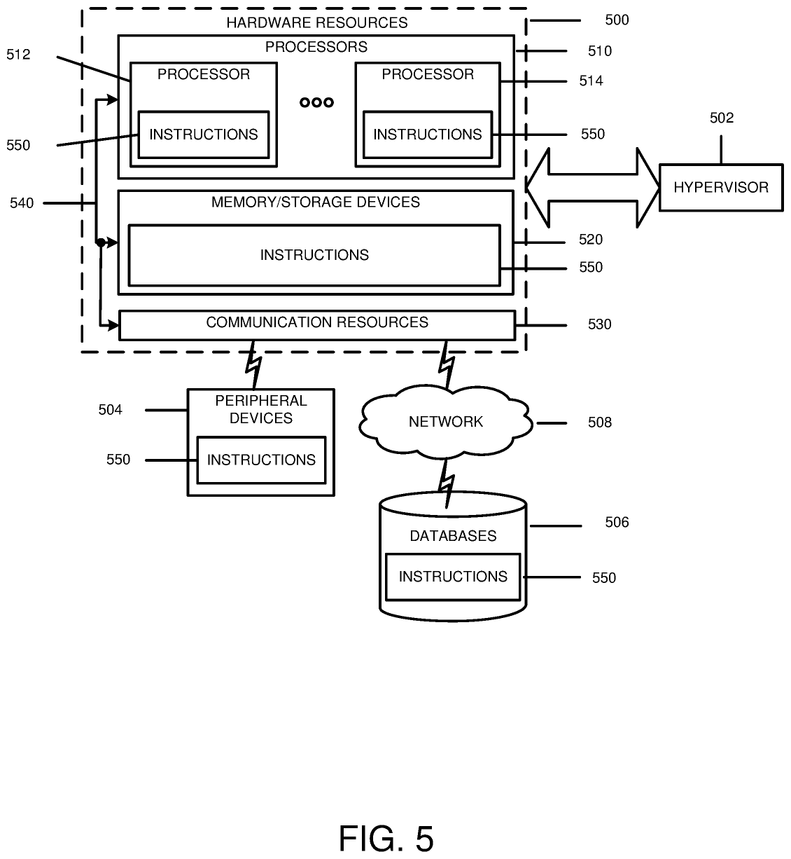

FIG. 5 is a block diagram 500 illustrating components, in accordance with one or more example embodiments of the present disclosure.

The components may be able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources from any combination of the peripheral devices 504 or the databases 506. Accordingly, the memory of processors 510, the memory/storage devices 520, the peripheral devices 504, and the databases 506 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Example 1 may be an apparatus of a user equipment device (UE) device for uplink transmissions, the apparatus comprising processing circuitry coupled to storage, the processing circuitry configured to: identify a first physical downlink control channel (PDCCH) transmission received from a 5th Generation node B (gNB) device at a first time; identify a second PDCCH transmission received from the gNB device at a second time; determine, based on the first PDCCH transmission, that the UE device is to transmit a first physical uplink control channel (PUCCH) transmission or a first physical uplink shared control channel (PUSCH) transmission to the gNB device; determine, based on the second PDCCH transmission, that the UE device is to transmit a second PUCCH transmission or a second PUSCH transmission to the gNB device at a third time overlapping the first PUCCH transmission or the first PUSCH transmission; set a time period after the second PDCCH transmission and during which the UE device is to refrain from transmitting the second PUCCH transmission or the second PUSCH transmission to the gNB device, the time period based on a preparation time for the UE device to generate the second PUSCH transmission after receiving the second PDCCH transmission; and cause an antenna of the UE device to transmit the second PUCCH transmission or the second PUSCH transmission to the gNB device after expiration of the time period.

Example 2 may include the apparatus of example 1 and/or some other example herein, wherein the processing circuitry is configured to: determine that a first priority of the first PUCCH transmission or the first PUSCH transmission is less than a second priority of the second PUCCH transmission or the second PUSCH transmission, wherein the UE device transmits the second PUCCH transmission or the second PUSCH transmission to the gNB device and refrains from transmitting at least a portion of the first PUCCH transmission or the first PUSCH transmission based on the first priority and the second priority.

Example 3 may include the apparatus of example 1 or example 2 and/or some other example herein, wherein to set the time period further comprises to: determine a value indicative of a capability of the UE device; and set the time period based on a sum of the preparation time and the value.

Example 4 may include the apparatus of example 1 and/or some other example herein, wherein the time period is longer than the preparation time.

Example 5 may include the apparatus of example 3 and/or some other example herein, wherein to set the time period further comprises to: identify a smallest subcarrier spacing associated with at least one of the first PDCCH transmission, the second PDCCH transmission, the first PUCCH transmission, the second PUCCH transmission, the first PUSCH transmission, or the second PUSCH transmission; and set time period based on the subcarrier spacing.

Example 6 may include the apparatus of example 4 and/or some other example herein, wherein the second PDCCH transmission comprises an indication of a time slot offset associated with transmitting the second PUCCH transmission or the second PUSCH transmission, and wherein the time period is set based on the time slot offset.

Example 7 may include the apparatus of example 1 and/or some other example herein, wherein the processing circuitry is further configured to stop transmitting the first PUCCH transmission or the first PUSCH transmission prior to transmitting the second PUCCH transmission or the second PUSCH transmission.

Example 8 may include the apparatus of example 1 and/or some other example herein, wherein the processing circuitry is further configured to refrain from transmitting the first PUCCH transmission or the first PUSCH transmission prior to transmitting the second PUCCH transmission or the second PUSCH transmission.

Example 9 may include a computer-readable storage medium comprising instructions to cause processing circuitry of a user equipment device (UE) device, upon execution of the instructions by the processing circuitry, to: identify a first physical downlink control channel (PDCCH) transmission received from a 5th Generation node B (gNB) device at a first time; identify a second PDCCH transmission received from the gNB device at a second time; determine, based on the first PDCCH transmission, that the UE device is to transmit a first physical uplink control channel (PUCCH) transmission or a first physical uplink shared control channel (PUSCH) transmission to the gNB device; determine, based on the second PDCCH transmission, that the UE device is to transmit a second PUCCH transmission or a second PUSCH to the gNB device at a second time overlapping the transmission of the first PUCCH transmission or the first PUSCH transmission; set a time period after the second PDCCH transmission and during which the UE is to refrain from transmitting the second PUCCH transmission or the second PUSCH transmission to the gNB device, the time based on a preparation time for the UE device to generate the second PUSCH transmission after receiving the second PDCCH transmission; and cause an antenna of the UE device to transmit the second PUCCH transmission or the second PUSCH transmission to the gNB device after expiration of the time period.

Example 10 may include the computer-readable medium of example 9 and/or some other example herein, wherein execution of the instructions further causes the processing circuitry to: determine that a first priority of the first PUCCH transmission or the second PUSCH transmission is less than a second priority of the second PUCCH transmission or the second PUSCH transmission, wherein the UE device transmits the second PUCCH transmission or the second PUSCH transmission to the gNB device and refrains from transmitting at least a portion of the first PUCCH transmission or the first PUSCH transmission based on the first priority and the second priority.

Example 11 may include the computer-readable medium of example 9 or example 10 and/or some other example herein, wherein to set the time period further comprises to: determine a value indicative of a capability of the UE device; and set the time period based on a sum of the preparation time and the value.

Example 12 may include the computer-readable medium of example 11 and/or some other example herein, wherein the time period is longer than the preparation time.

Example 13 may include the computer-readable medium of example 12 and/or some other example herein, wherein to set the time period further comprises to: identify a smallest subcarrier spacing associated with at least one of the first PDCCH transmission, the second PDCCH transmission, the first PUCCH transmission, the second PUCCH transmission, the first PUSCH transmission, or the second PUSCH transmission; and set the time period based on the subcarrier spacing.

Example 14 may include the computer-readable medium of example 12 and/or some other example herein, wherein the second PDCCH transmission comprises an indication of a time slot offset associated with transmitting the second PUCCH transmission or the second PUSCH transmission, and wherein the time period is set based on the time slot offset.

Example 15 may include the computer-readable medium of example 12 and/or some other example herein, wherein execution of the instructions further causes the processing circuitry to stop transmitting the first PUCCH transmission or the first PUSCH transmission prior to transmitting the second PUCCH transmission or the second PUSCH transmission.

Example 16 may include the computer-readable medium of example 9 and/or some other example herein, wherein execution of the instructions further causes the processing circuitry to refrain from transmitting the first PUCCH transmission or the first PUSCH transmission prior to transmitting the second PUCCH transmission or the second PUSCH transmission.

Example 17 may include a method for uplink transmissions, the method comprising: identifying, by processing circuitry of a user equipment (UE) device, a first physical downlink control channel (PDCCH) transmission received from a 5th Generation node B (gNB) device at a first time; identifying, by the processing circuitry, a second PDCCH transmission received from the gNB device at a second time; determining, by the processing circuitry, based on the first PDCCH transmission, that the UE device is to transmit a first physical uplink control channel (PUCCH) transmission or a first physical uplink shared control channel (PUSCH) transmission to the gNB device; determining, by the processing circuitry, based on the second PDCCH transmission, that the UE device is to transmit a second PUCCH transmission or a second PUSCH transmission to the gNB device at a third time overlapping the first PUCCH transmission or the first PUSCH transmission; setting, by the processing circuitry, a time period after the second PDCCH transmission and during which the UE device is to refrain from transmitting the second PUCCH transmission or the second PUSCH transmission to the gNB device, the time period based on a preparation time for the UE device to generate the second PUSCH transmission after receiving the second PDCCH; and causing, by the processing circuitry, an antenna of the UE device to transmit the second PUCCH transmission or the second PUSCH transmission to the gNB device after expiration of the time period.

Example 18 may include the method of example 17 and/or some other example herein, further comprising: determining that a first priority of the first PUCCH transmission or the first PUSCH transmission is less than a second priority of the second PUCCH transmission or the second PUSCH transmission, wherein the UE device transmits the second PUCCH transmission or the second PUSCH transmission to the gNB device and refrains from transmitting at least a portion of the first PUCCH transmission or the first PUSCH transmission based on the first priority and the second priority.

Example 19 may include the method of example 17 or example 18 and/or some other example herein, wherein setting the time period comprises: determining a value indicative of a capability of the UE device; and setting the time period based on a sum of the preparation time and the value.

Example 20 may include the method of example 19 and/or some other example herein, wherein the time period is longer than the preparation time.

Example 21 may include the method of example 19 and/or some other example herein, wherein setting the time period further comprises: identifying a smallest subcarrier spacing associated with at least one of the first PDCCH transmission, the second PDCCH transmission, the first PUCCH transmission, the second PUCCH transmission, the first PUSCH transmission, or the second PUSCH transmission; and set the time period based on the subcarrier spacing.

Example 22 may include the method of example 19 and/or some other example herein, wherein the PDCCH transmission comprises an indication of a time slot offset associated with transmitting the second PUCCH transmission or the second PUSCH transmission, and wherein the time period is set based on the time slot offset, and wherein the time period is set based on the time slot offset.

Example 23 may include the method of example 17 and/or some other example herein, further comprising stopping transmission of the first PUCCH transmission or the first PUSCH transmission prior to transmitting the second PUCCH transmission or the second PUSCH transmission.

Example 24 may include an apparatus comprising means for: identifying, by a user equipment (UE) device, a first physical downlink control channel (PDCCH) transmission received from a 5th Generation node B (gNB) device at a first time; identifying a second PDCCH transmission received from the gNB device at a second time; determining, based on the first PDCCH transmission, that the UE device is to transmit a first physical uplink control channel (PUCCH) transmission or a first physical uplink shared control channel (PUSCH) transmission to the gNB device; determining, based on the second PDCCH transmission, that the UE device is to transmit a second PUCCH transmission or a second PUSCH transmission to the gNB device at a third time overlapping the first PUCCH transmission or the first PUSCH transmission; setting a time period after the second PDCCH transmission and during which the UE device is to refrain from transmitting the second PUCCH transmission or the second PUSCH transmission to the gNB device, the time period based on a preparation time for the UE device to generate the second PUSCH transmission after receiving the second PDCCH; and causing an antenna of the UE device to transmit the second PUCCH transmission or the second PUSCH transmission to the gNB device after expiration of the time period.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 1) may apply to the examples and embodiments discussed herein.

TABLE 1
Abbreviations:

| | | |
|---|---|---|
| 3GPP Third Generation | IBE In-Band Emission | PUSCH Physical Uplink Shared |
| Partnership Project | | Channel |
| 4G Fourth Generation | IEEE Institute of Electrical | QAM Quadrature Amplitude |
| | and Electronics Engineers | Modulation |
| 5G Fifth Generation | IEI Information Element | QCI QoS class of identifier |
| | Identifier | |
| 5GC 5G Core network | IEIDL Information Element | QCL Quasi co-location |
| | Identifier Data Length | |
| AC Application Client | IETF Internet Engineering | QFI QoS Flow ID, QoS |
| | Task Force | Flow Identifier |
| ACK Acknowledgement | IF Infrastructure | QoS Quality of Service |
| ACID Application Client | IM Interference | QPSK Quadrature |
| Identification | Measurement, | (Quaternary) Phase |
| | Intermodulation, IP | Shift Keying |
| | Multimedia | |
| AF Application Function | IMC IMS Credentials | QZSS Quasi-Zenith Satellite |
| | | System |
| AM Acknowledged Mode | IMEI International Mobile | RA-RNTI Random Access RNTI |
| | Equipment Identity | |
| AMBR Aggregate Maximum Bit | IMGI International mobile | RAB Radio Access Bearer, |
| Rate | group identity | Random Access Burst |
| AMF Access and Mobility | IMPI IP Multimedia Private | RACH Random Access |
| Management Function | Identity | Channel |
| AN Access Network | IMPU IP Multimedia PUblic | RADIUS Remote Authentication |
| | identity | Dial In User Service |
| ANR Automatic Neighbour | IMS IP Multimedia | RAN Radio Access Network |
| Relation | Subsystem | |
| AP Application Protocol, | IMSI International Mobile | RAND RANDom number |
| Antenna Port, Access Point | Subscriber Identity | (used for authentication) |
| API Application Programming | IoT Internet of Things | RAR Random Access Response |
| Interface | | |
| APN Access Point Name | IP Internet Protocol | RAT Radio Access |
| | | Technology |
| ARP Allocation and Retention | Ipsec IP Security, Internet | RAU Routing Area Update |
| Priority | Protocol Security | |
| ARQ Automatic Repeat Request | IP-CAN IP-Connectivity | RB Resource block, Radio |
| | Access Network | Bearer |
| AS Access Stratum | IP-M IP Multicast | RBG Resource block group |
| ASP Application Service | IPv4 Internet Protocol | REG Resource Element |
| Provider | Version 4 | Group |
| ASN.1 Abstract Syntax Notation | IPv6 Internet Protocol | Rel Release |
| One | Version 6 | |
| AUSF Authentication Server | IR Infrared | REQ REQuest |
| Function | | |
| AWGN Additive White Gaussian | IS In Sync | RF Radio Frequency |
| Noise | | |
| BAP Backhaul Adaptation | IRP Integration Reference | RI Rank Indicator |
| Protocol | Point | |
| BCH Broadcast Channel | ISDN Integrated Services | RIV Resource indicator |
| | Digital Network | value |
| BER Bit Error Ratio | ISIM IM Services Identity | RL Radio Link |
| | Module | |
| BFD Beam Failure Detection | ISO International | RLC Radio Link Control, |
| | Organisation for | Radio Link Control |
| | Standardisation | layer |
| BLER Block Error Rate | ISP Internet Service | RLC AM RLC Acknowledged |
| | Provider | Mode |
| BPSK Binary Phase Shift Keying | IWF Interworking-Function | RLC UM RLC Unacknowledged |
| | | Mode |
| BRAS Broadband Remote | I-WLAN Interworking WLAN | RLF Radio Link Failure |
| Access Server | | |
| BSS Business Support System | Constraint length of the | RLM Radio Link Monitoring |
| | convolutional code, USIM | |
| | Individual key | |
| BS Base Station | kB Kilobyte (1000 bytes) | RLM-RS Reference Signal for |
| | | RLM |
| BSR Buffer Status Report | kbps kilo-bits per second | RM Registration |
| | | Management |
| BW Bandwidth | Kc Ciphering key | RMC Reference |
| | | Measurement Channel |
| BWP Bandwidth Part | Ki Individual subscriber | RMSI Remaining MSI, |
| | authentication key | Remaining Minimum |
| | | System Information |
| C-RNTI Cell Radio Network | KPI Key Performance | RN Relay Node |
| Temporary Identity | Indicator | |
| CA Carrier Aggregation, | KQI Key Quality Indicator | RNC Radio Network |
| Certification Authority | | Controller |
| CAPEX CAPital EXpenditure | KSI Key Set Identifier | RNL Radio Network Layer |
| CBRA Contention Based Random | ksps kilo-symbols per | RNTI Radio Network |
| Access | second | Temporary Identifier |
| CC Component Carrier, | KVM Kernel Virtual | ROHC RObust Header |
| Country Code, | Machine | Compression |
| Cryptographic Checksum | | |
| CCA Clear Channel Assessment | L1 Layer 1 (physical | RRC Radio Resource |
| | layer) | Control, Radio |
| | | Resource Control layer |
| CCE Control Channel Element | L1-RSRP Layer 1 reference | RRM Radio Resource |
| | signal received power | Management |
| CCCH Common Control Channel | L2 Layer 2 (data link | RS Reference Signal |
| | layer) | |
| CE Coverage Enhancement | L3 Layer 3 (network | RSRP Reference Signal |
| | layer) | Received Power |
| CDM Content Delivery Network | LAA Licensed Assisted | RSRQ Reference Signal |
| | Access | Received Quality |
| CDMA Code-Division Multiple | LAN Local Area Network | RSSI Received Signal |
| Access | | Strength Indicator |
| CFRA Contention Free Random | LADN Local Area Data | RSU Road Side Unit |
| Access | Network | |
| CG Cell Group | LBT Listen Before Talk | RSTD Reference Signal Time |
| | | difference |
| CGF Charging Gateway | LCM LifeCycle | RTP Real Time Protocol |
| Function | Management | |
| CHF Charging Function | LCR Low Chip Rate | RTS Ready-To-Send |
| CI Cell Identity | LCS Location Services | RTT Round Trip Time |
| CID Cell-ID (e.g., positioning | LCID Logical Channel ID | Rx Reception, Receiving, |
| method) | | Receiver |
| CIM Common Information | LI Layer Indicator | S1AP S1 Application |
| Model | | Protocol |
| CIR Carrier to Interference | LLC Logical Link Control, | S1-MMES1 for the control plane |
| Ratio | Low Layer Compatibility | |
| CK Cipher Key | LPLMN Local PLMN | S1-U S1 for the user plane |
| CM Connection Management, | LPP LTE Positioning | S-GW Serving Gateway |
| Conditional Mandatory | Protocol | |
| CMAS Commercial Mobile Alert | LSB Least Significant Bit | S-RNTI SRNC Radio Network |
| Service | | Temporary Identity |
| CMD Command | LTE Long Term Evolution | S-TMSI SAE Temporary |
| | | Mobile Station Identifier |
| CMS Cloud Management | LWA LTE-WLAN | SA Standalone operation |
| System | aggregation | mode |
| CO Conditional Optional | LWIP LTE/WLAN Radio | SAE System Architecture |
| | Level Integration with | Evolution |
| | IPsec Tunnel | |
| CoMP Coordinated Multi-Point | LTE Long Term Evolution | SAP Service Access Point |
| CORESET Control Resource Set | M2M Machine-to-Machine | SAPD Service Access Point |
| | | Descriptor |
| COTS Commercial Off-The- | MAC Medium Access | SAPI Service Access Point |
| Shelf | Control (protocol | Identifier |
| | layering context) | |
| CP Control Plane, Cyclic | MAC Message authentication | SCC Secondary Component |
| Prefix, Connection Point | code (security/encryption | Carrier, Secondary CC |
| | context) | |
| CPD Connection Point | MAC-A MAC used for | SCell Secondary Cell |
| Descriptor | authentication and key | |
| | agreement (TSG T | |
| | WG3 context) | |
| CPE Customer Premise | MAC-I MAC used for data | SCEF Service Capability |
| Equipment | integrity of signalling | Exposure Function |
| | messages (TSG T | |
| | WG3 context) | |
| CPICH Common Pilot Channel | MANO Management and | SC-FDMA Single Carrier |
| | Orchestration | Frequency Division |
| | | Multiple Access |
| CQI Channel Quality Indicator | MBMS Multimedia Broadcast | SCG Secondary Cell Group |
| | and Multicast Service | |
| CPU CSI processing unit, | MBSFN Multimedia Broadcast | SCM Security Context |
| Central Processing Unit | multicast service Single | Management |
| | Frequency Network | |
| C/R Command/Response field | MCC Mobile Country Code | SCS Subcarrier Spacing |
| bit | | |
| CRAN Cloud Radio Access | MCG Master Cell Group | SCTP Stream Control |
| Network, Cloud RAN | | Transmission Protocol |
| CRB Common Resource Block | MCOT Maximum Channel | SDAP Service Data |
| | Occupancy Time | Adaptation Protocol, |
| | | Service Data |
| | | Adaptation Protocol |
| | | layer |
| CRC Cyclic Redundancy Check | MCS Modulation and coding | SDL Supplementary |
| | scheme | Downlink |
| CRI Channel-State Information | MDAF Management Data | SDNF Structured Data |
| Resource Indicator, CSI- | Analytics Function | Storage Network |
| RS Resource Indicator | | Function |
| C-RNTI Cell RNTI | MDAS Management Data | SDP Session Description |
| | Analytics Service | Protocol |
| CS Circuit Switched | MDT Minimization of Drive | SDSF Structured Data |
| | Tests | Storage Function |
| CSAR Cloud Service Archive | ME Mobile Equipment | SDU Service Data Unit |
| CSI Channel-State Information | MeNB master eNB | SEAF Security Anchor |
| | | Function |
| CSI-IM CSI Interference | MER Message Error Ratio | SeNB secondary eNB |
| Measurement | | |
| CSI-RS CSI Reference Signal | MGL Measurement Gap | SEPP Security Edge |
| | Length | Protection Proxy |
| CSI-RSRP CSI reference signal | MGRP Measurement Gap | SFI Slot format indication |
| received power | Repetition Period | |
| CSI-RSRQ CSI reference signal | MIB Master Information | SFTD Space-Frequency Time |
| received quality | Block, Management | Diversity, SFN and |
| | Information Base | frame timing difference |
| CSI-SINR CSI signal-to-noise and | MIMO Multiple Input | SFN System Frame Number |
| interference ratio | Multiple Output | |
| CSMA Carrier Sense Multiple | MLC Mobile Location | SgNB Secondary gNB |
| Access | Centre | |
| CSMA/CA CSMA with collision | MM Mobility Management | SGSN Serving GPRS Support |
| avoidance | | Node |
| CSS Common Search Space, | MME Mobility Management | S-GW Serving Gateway |
| Cell-specific Search Space | Entity | |
| CTF Charging Trigger Function | MN Master Node | SI System Information |
| CTS Clear-to-Send | MNO Mobile Network | SI-RNTI System Information |
| | Operator | RNTI |
| CW Codeword | MO Measurement Object, | SIB System Information |
| | Mobile Originated | Block |
| CWS Contention Window Size | MPBCH MTC Physical | SIM Subscriber Identity |
| | Broadcast CHannel | Module |
| D2D Device-to-Device | MPDCCH MTC Physical | SIP Session Initiated |
| | Downlink Control CHannel | Protocol |
| DC Dual Connectivity, Direct | MPDSCH MTC Physical | SiP System in Package |
| Current | Downlink Shared CHannel | |
| DCI Downlink Control | MPRACH MTC Physical | SL Sidelink |
| Information | Random Access CHannel | |
| DF Deployment Flavour | MPUSCH MTC Physical Uplink | SLA Service Level |
| | Shared Channel | Agreement |
| DL Downlink | MPLS MultiProtocol Label | SM Session Management |
| | Switching | |
| DMTF Distributed Management | MS Mobile Station | SMF Session Management |
| Task Force | | Function |
| DPDK Data Plane Development | MSB Most Significant Bit | SMS Short Message Service |
| Kit | | |
| DM-RS, DMRS Demodulation | MSC Mobile Switching | SMSF SMS Function |
| Reference Signal | Centre | |
| DN Data network | MSI Minimum System | SMTC SSB-based |
| | Information, MCH | Measurement Timing |
| | Scheduling Information | Configuration |
| DNN Data Network Name | MSID Mobile Station | SN Secondary Node, |
| | Identifier | Sequence Number |
| DNAI Data Network Access | MSIN Mobile Station | SoC System on Chip |
| Identifier | Identification Number | |
| DRB Data Radio Bearer | MSISDN Mobile Subscriber | SON Self-Organizing |
| | ISDN Number | Network |
| DRS Discovery Reference | MT Mobile Terminated, | SpCell Special Cell |
| Signal | Mobile Termination | |
| DRX Discontinuous Reception | MTC Machine-Type | SP-CSI-RNTI Semi-Persistent |
| | Communications | CSI RNTI |
| DSL Domain Specific | mMTC massive MTC, massive | SPS Semi-Persistent |
| Language. Digital | Machine-Type | Scheduling |
| Subscriber Line | Communications | |
| DSLAM DSL Access Multiplexer | MU-MIMO Multi User MIMO | SQN Sequence number |
| DwPTS Downlink Pilot Time Slot | MWUS MTC wake-up signal, | SR Scheduling Request |
| | MTC WUS | |
| E-LAN Ethernet Local Area | NACK Negative | SRB Signalling Radio |
| Network | Acknowledgement | Bearer |
| E2E End-to-End | NAI Network Access | SRS Sounding Reference |
| | Identifier | Signal |
| ECCA extended clear channel | NAS Non-Access Stratum, | SS Synchronization Signal |
| assessment, extended CCA | Non-Access Stratum layer | |
| ECCE Enhanced Control | NCT Network Connectivity | SSB Synchronization Signal |
| Channel Element, | Topology | Block |
| Enhanced CCE | | |
| ED Energy Detection | NC-JT Non-Coherent Joint | SSID Service Set Identifier |
| | Transmission | |
| EDGE Enhanced Datarates for | NEC Network Capability | SS/PBCH Block |
| GSM Evolution (GSM Evolution) | Exposure | |
| EAS Edge Application Server | NE-DC NR-E-UTRA Dual | SSBRI SS/PBCH Block |
| | Connectivity | Resource Indicator, |
| | | Synchronization Signal |
| | | Block Resource Indicator |
| EASID Edge Application Server | NEF Network Exposure | SSC Session and Service |
| Identification | Function | Continuity |
| ECS Edge Configuration Server | NF Network Function | SS-RSRP Synchronization Signal |
| | | based Reference Signal Received |
| | | Power |
| ECSP Edge Computing Service | NFP Network Forwarding | SS-RSRQ Synchronization Signal |
| Provider | Path | based Reference Signal Received |
| | | Quality |
| EDN Edge Data Network | NFPD Network Forwarding | SS-SINR Synchronization Signal |
| | Path Descriptor | based Signal to Noise and |
| | | Interference Ratio |
| EEC Edge Enabler Client | NFV Network Functions | SSS Secondary |
| | Virtualization | Synchronization Signal |
| EECID Edge Enabler Client | NFVI NFV Infrastructure | SSSG Search Space Set |
| Identification | | Group |
| EES Edge Enabler Server | NFVO NFV Orchestrator | SSSIF Search Space Set |
| | | Indicator |
| EESID Edge Enabler Server | NG Next Generation, Next | SST Slice/Service Types |
| Identification | Gen | |
| EHE Edge Hosting | NGEN-DC NG-RAN E-UTRA- | SU-MIMO Single User MIMO |
| Environment | NR Dual Connectivity | |
| EGMF Exposure Governance | NM Network Manager | SUL Supplementary Uplink |
| tableManagement Function | | |
| EGPRS Enhanced GPRS | NMS Network Management | TA Timing Advance, |
| | System | Tracking Area |
| EIR Equipment Identity | N-PoP Network Point of | TAC Tracking Area Code |
| Register | Presence | |
| eLAA enhanced Licensed | NMIB, N-MIB Narrowband MIB | TAG Timing Advance Group |
| Assisted Access, enhanced | | |
| LAA | | |
| EM Element Manager | NPBCH Narrowband Physical | TAI Tracking Area Identity |
| | Broadcast CHannel | |
| eMBB Enhanced Mobile | NPDCCH Narrowband Physical | TAU Tracking Area Update |
| Broadband | Downlink Control CHannel | |
| EMS Element Management | NPDSCH Narrowband Physical | TB Transport Block |
| System | Downlink Shared CHannel | |
| eNB evolved NodeB, E- | NPRACH Narrowband Physical | TBS Transport Block Size |
| UTRAN Node B | Random Access CHannel | |
| EN-DC E-UTRA-NR Dual | NPUSCH Narrowband Physical | TBD To Be Defined |
| Connectivity | Uplink Shared CHannel | |
| EPC Evolved Packet Core | NPSS Narrowband Primary | TCI Transmission |
| | Synchronization Signal | Configuration Indicator |
| EPDCCH enhanced PDCCH, | NSSS Narrowband | TCP Transmission |
| enhanced Physical | Secondary | Communication |
| Downlink Control Cannel | Synchronization Signal | Protocol |
| EPRE Energy per resource | NR New Radio, Neighbour | TDD Time Division Duplex |
| element | Relation | |
| EPS Evolved Packet System | NRF NF Repository | TDM Time Division |
| | Function | Multiplexing |
| EREG enhanced REG, enhanced | NRS Narrowband Reference | TDMA Time Division Multiple |
| resource element groups | Signal | Access |
| ETSI European | NS Network Service | TE Terminal Equipment |
| Telecommunications | | |
| Standards Institute | | |
| ETWS Earthquake and Tsunami | NSA Non-Standalone | TEID Tunnel End Point |
| Warning System | operation mode | Identifier |
| eUICC embedded UICC, | NSD Network Service | TFT Traffic Flow Template |
| embedded Universal | Descriptor | |
| Integrated Circuit Card | | |
| E-UTRA Evolved UTRA | NSR Network Service | TMSI Temporary Mobile |
| | Record | Subscriber Identity |
| E-UTRAN Evolved UTRAN | NSSAI Network Slice | TNL Transport Network |
| | Selection Assistance | Layer |
| | Information | |
| EV2X Enhanced V2X | S-NNSAI Single-NSSAI | TPC Transmit Power |
| | | Control |
| F1AP F1 Application Protocol | NSSF Network Slice | TPMI Transmitted Precoding |
| | Selection Function | Matrix Indicator |
| F1-C F1 Control plane interface | NW Network | TR Technical Report |
| F1-U F1 User plane interface | NWUS Narrowband wake-up | TRP, TRxP Transmission |
| | signal, Narrowband WUS | Reception Point |
| FACCH Fast Associated Control | NZP Non-Zero Power | TRS Tracking Reference |
| CHannel | | Signal |
| FACCH/F Fast Associated Control | O&M Operation and | TRx Transceiver |
| Channel/Full rate | Maintenance | |
| FACCH/H Fast Associated Control | ODU2 Optical channel Data | TS Technical |
| Channel/Half rate | Unit - type 2 | Specifications, |
| | | Technical Standard |
| FACH Forward Access Channel | OFDM Orthogonal Frequency | TTI Transmission Time |
| | Division Multiplexing | Interval |
| FAUSCH Fast Uplink Signalling | OFDMA Orthogonal Frequency | Tx Transmission, |
| Channel | Division Multiple | Transmitting, |
| | Access | Transmitter |
| FB Functional Block | OOB Out-of-band | U-RNTI UTRAN Radio |
| | | Network Temporary |
| | | Identity |
| FBI Feedback Information | OOS Out of Sync | UART Universal |
| | | Asynchronous |
| | | Receiver and |
| | | Transmitter |
| FCC Federal Communications | OPEX OPerating EXpense | UCI Uplink Control |
| Commission | | Information |
| FCCH Frequency Correction | OSI Other System | UE User Equipment |
| CHannel | Information | |
| FDD Frequency Division | OSS Operations Support | UDM Unified Data |
| Duplex | System | Management |
| FDM Frequency Division | OTA over-the-air | UDP User Datagram |
| Multiplex | | Protocol |
| FDMA Frequency Division | PAPR Peak-to-Average | UDSF Unstructured Data |
| Multiple Access | Power Ratio | Storage Network Function |
| FE Front End | PAR Peak to Average Ratio | UICC Universal Integrated |
| | | Circuit Card |
| FEC Forward Error Correction | PBCH Physical Broadcast | UL Uplink |
| | Channel | |
| FFS For Further Study | PC Power Control, | UM Unacknowledged |
| | Personal Computer | Mode |
| FFT Fast Fourier | PCC Primary Component | UML Unified Modelling |
| Transformation | Carrier, Primary CC | Language |
| feLAA further enhanced Licensed | PCell Primary Cell | UMTS Universal Mobile |
| Assisted Access, further | | Telecommunications |
| enhanced LAA | | System |
| FN Frame Number | PCI Physical Cell ID, | UP User Plane |
| | Physical Cell Identity | |
| FPGA Field-Programmable Gate | PCEF Policy and Charging | UPF User Plane Function |
| Array | Enforcement Function | |
| FR Frequency Range | PCF Policy Control | URI Uniform Resource |
| | Function | Identifier |
| FQDN Fully Qualified Domain | PCRF Policy Control and | URL Uniform Resource |
| Name | Charging Rules Function | Locator |
| G-RNTI GERAN Radio Network | PDCP Packet Data | URLLC Ultra-Reliable and Low |
| Temporary Identity | Convergence Protocol, | Latency |
| | Packet Data Convergence | |
| | Protocol layer | |
| GERAN GSM EDGE RAN, GSM | PDCCH Physical Downlink | USB Universal Serial Bus |
| EDGE Radio Access Network | Control Channel | |
| GGSN Gateway GPRS Support | PDCP Packet Data | USIM Universal Subscriber |
| Node | Convergence Protocol | Identity Module |
| GLONASS GLObal′naya | PDN Packet Data Network, | USS UE-specific search |
| NAvigatsionnaya | Public Data Network | space |
| Sputnikovaya Sistema | | |
| (Engl .: Global Navigation | | |
| Satellite System) | | |
| gNB Next Generation NodeB | PDSCH Physical Downlink | UTRA UMTS Terrestrial |
| | Shared Channel | Radio Access |
| gNB-CUgNB-centralized unit, Next | PDU Protocol Data Unit | UTRAN Universal Terrestrial |
| Generation NodeB centralized unit | | Radio Access Network |
| gNB-DUgNB-distributed unit, Next | PEI Permanent Equipment | UwPTS Uplink Pilot Time Slot |
| Generation NodeB centralized unit | Identifiers | |
| GNSS Global Navigation | PFD Packet Flow | V2I Vehicle-to- |
| Satellite System | Description | Infrastruction |
| GPRS General Packet Radio | P-GW PDN Gateway | V2P Vehicle-to-Pedestrian |
| Service | | |
| GPSI Generic Public | PHICH Physical hybrid-ARQ | V2V Vehicle-to-Vehicle |
| Subscription Identifier | indicator channel | |
| GSM Global System for Mobile | PHY Physical layer | V2X Vehicle-to-everything |
| Communications, Groupe | | |
| Spécial Mobile | | |
| GTP GPRS Tunneling Protocol | PLMN Public Land Mobile | VIM Virtualized |
| | Network | Infrastructure Manager |
| GTP-U GPRS Tunnelling Protocol | PIN Personal Identification | VL Virtual Link, |
| for User Plane | Number | |
| GTS Go To Sleep Signal | PM Performance | VLAN Virtual LAN, Virtual |
| (related to WUS) | Measurement | Local Area Network |
| GUMMEI Globally Unique MME | PMI Precoding Matrix | VM Virtual Machine |
| Identifier | Indicator | |
| GUTI Globally Unique | PNF Physical Network | VNF Virtualized Network |
| Temporary UE Identity | Function | Function |
| HARQ Hybrid ARQ, Hybrid | PNFD Physical Network | VNFFG VNF Forwarding |
| Automatic Repeat Request | Function Descriptor | Graph |
| HANDO Handover | PNFR Physical Network | VNFFGD VNF Forwarding |
| | Function Record | Graph Descriptor |
| HFN HyperFrame Number | POC PTT over Cellular | VNFM VNF Manager |
| HHO Hard Handover | PP, PTP Point-to-Point | VoIP Voice-over-IP, Voice- |
| | | over-Internet Protocol |
| HLR Home Location Register | PPP Point-to-Point Protocol | VPLMN Visited Public Land |
| | | Mobile Network |
| HN Home Network | PRACH Physical RACH | VPN Virtual Private |
| | | Network |
| HO Handover | PRB Physical resource | VRB Virtual Resource Block |
| | block | |
| HPLMN Home Public Land Mobile | PRG Physical resource | WiMAX Worldwide |
| Network | block group | Interoperability for |
| | | Microwave Access |
| HSDPA High Speed Downlink | ProSe Proximity Services, | WLAN Wireless Local Area |
| Packet Access | Proximity-Based | Network |
| | Service | |
| HSN Hopping Sequence | PRS Positioning Reference | WMAN Wireless Metropolitan |
| Number | Signal | Area Network |
| HSPA High Speed Packet Access | PRR Packet Reception | WPAN Wireless Personal Area |
| | Radio | Network |
| HSS Home Subscriber Server | PS Packet Services | X2-C X2-Control plane |
| HSUPA High Speed Uplink Packet | PSBCH Physical Sidelink | X2-U X2-User plane |
| Access | Broadcast Channel | |
| HTTP Hyper Text Transfer | PSDCH Physical Sidelink | XML eXtensible Markup |
| Protocol | Downlink Channel | Language |
| HTTPS Hyper Text Transfer | PSCCH Physical Sidelink | XRES EXpected user |
| Protocol Secure (https is | Control Channel | RESponse |
| http/1.1 over SSL, i.e. port | | |
| 443) | | |
| I-Block Information Block | PSSCH Physical Sidelink | XOR eXclusive OR |
| | Shared Channel | |
| ICCID Integrated Circuit Card | PSCell Primary SCell | ZC Zadoff-Chu |
| Identification | | |
| IAB Integrated Access and | PSS Primary | ZP Zero Po |
| Backhaul | Synchronization Signal | |
| ICIC Inter-Cell Interference | PSTN Public Switched | |
| Coordination | Telephone Network | |
| ID Identity, identifier | PT-RS Phase-tracking | |
| | reference signal | |
| IDFT Inverse Discrete Fourier | PTT Push-to-Talk | |
| Transform | | |
| IE Information element | PUCCH Physical Uplink | |
| | Control Channel | |

What is claimed is:

1. An apparatus of a user equipment device (UE) device for uplink transmissions, the apparatus comprising processing circuitry coupled to storage, the processing circuitry configured to:
identify a first physical downlink control channel (PDCCH) transmission received from a 5^{th} Generation node B (gNB) device at a first time;
identify a second PDCCH transmission received from the gNB device at a second time;
determine, based on the first PDCCH transmission, that the UE device is to transmit a first physical uplink control channel (PUCCH) transmission or a first physical uplink shared control channel (PUSCH) transmission to the gNB device;
determine, based on the second PDCCH transmission, that the UE device is to transmit a second PUCCH transmission or a second PUSCH transmission to the gNB device at a third time overlapping the first PUCCH transmission or the first PUSCH transmission;
set a time period after the second PDCCH transmission and during which the UE device is to refrain from transmitting the second PUCCH transmission or the second PUSCH transmission to the gNB device, the time period based on a preparation time for the UE device to generate the second PUSCH transmission after receiving the second PDCCH transmission; and
cause an antenna of the UE device to transmit the second PUCCH transmission or the second PUSCH transmission to the gNB device after expiration of the time period.

2. The apparatus of claim 1, wherein the processing circuitry is configured to:
determine that a first priority of the first PUCCH transmission or the first PUSCH transmission is less than a second priority of the second PUCCH transmission or the second PUSCH transmission,
wherein the UE device transmits the second PUCCH transmission or the second PUSCH transmission to the gNB device and refrains from transmitting at least a portion of the first PUCCH transmission or the first PUSCH transmission based on the first priority and the second priority.

3. The apparatus of claim 1 or claim 2, wherein to set the time period further comprises to:
determine a value indicative of a capability of the UE device; and
set the time period based on a sum of the preparation time and the value.

4. The apparatus of claim 3, wherein the time period is longer than the preparation time.

5. The apparatus of claim 3, wherein to set the time period further comprises to:
identify a smallest subcarrier spacing associated with at least one of the first PDCCH transmission, the second PDCCH transmission, the first PUCCH transmission, the second PUCCH transmission, the first PUSCH transmission, or the second PUSCH transmission; and
set time period based on the subcarrier spacing.

6. The apparatus of claim 4, wherein the second PDCCH transmission comprises an indication of a time slot offset associated with transmitting the second PUCCH transmission or the second PUSCH transmission, and wherein the time period is set based on the time slot offset.

7. The apparatus of claim 1, wherein the processing circuitry is further configured to stop transmitting the first PUCCH transmission or the first PUSCH transmission prior to transmitting the second PUCCH transmission or the second PUSCH transmission.

8. The apparatus of claim 1, wherein the processing circuitry is further configured to refrain from transmitting the first PUCCH transmission or the first PUSCH transmission prior to transmitting the second PUCCH transmission or the second PUSCH transmission.

9. A non-transitory computer-readable storage medium comprising instructions to cause processing circuitry of a user equipment device (UE) device, upon execution of the instructions by the processing circuitry, to:
identify a first physical downlink control channel (PDCCH) transmission received from a 5^{th} Generation node B (gNB) device at a first time;
identify a second PDCCH transmission received from the gNB device at a second time;
determine, based on the first PDCCH transmission, that the UE device is to transmit a first physical uplink control channel (PUCCH) transmission or a first physical uplink shared control channel (PUSCH) transmission to the gNB device;
determine, based on the second PDCCH transmission, that the UE device is to transmit a second PUCCH transmission or a second PUSCH to the gNB device at a second time overlapping the transmission of the first PUCCH transmission or the first PUSCH transmission;
set a time period after the second PDCCH transmission and during which the UE is to refrain from transmitting the second PUCCH transmission or the second PUSCH transmission to the gNB device, the time based on a preparation time for the UE device to generate the second PUSCH transmission after receiving the second PDCCH transmission; and
cause an antenna of the UE device to transmit the second PUCCH transmission or the second PUSCH transmission to the gNB device after expiration of the time period.

10. The non-transitory computer-readable medium of claim 9, wherein execution of the instructions further causes the processing circuitry to:
determine that a first priority of the first PUCCH transmission or the second PUSCH transmission is less than a second priority of the second PUCCH transmission or the second PUSCH transmission,
wherein the UE device transmits the second PUCCH transmission or the second PUSCH transmission to the gNB device and refrains from transmitting at least a portion of the first PUCCH transmission or the first PUSCH transmission based on the first priority and the second priority.

11. The non-transitory computer-readable medium of claim 9 or claim 10, wherein to set the time period further comprises to:
determine a value indicative of a capability of the UE device; and
set the time period based on a sum of the preparation time and the value.

12. The non-transitory computer-readable medium of claim 11, wherein the time period is longer than the preparation time.

13. The non-transitory computer-readable medium of any claim 12, wherein to set the time period further comprises to:
identify a smallest subcarrier spacing associated with at least one of the first PDCCH transmission, the second PDCCH transmission, the first PUCCH transmission, the second PUCCH transmission, the first PUSCH transmission, or the second PUSCH transmission; and
set the time period based on the subcarrier spacing.

14. The non-transitory computer-readable medium of claim 12, wherein the second PDCCH transmission comprises an indication of a time slot offset associated with transmitting the second PUCCH transmission or the second PUSCH transmission, and wherein the time period is set based on the time slot offset.

15. The non-transitory computer-readable medium of claim 12, wherein execution of the instructions further causes the processing circuitry to stop transmitting the first PUCCH transmission or the first PUSCH transmission prior to transmitting the second PUCCH transmission or the second PUSCH transmission.

16. The non-transitory computer-readable medium of claim 9, wherein execution of the instructions further causes the processing circuitry to refrain from transmitting the first PUCCH transmission or the first PUSCH transmission prior to transmitting the second PUCCH transmission or the second PUSCH transmission.

17. A method for uplink transmissions, the method comprising:
identifying, by processing circuitry of a user equipment (UE) device, a first physical downlink control channel (PDCCH) transmission received from a 5^{th} Generation node B (gNB) device at a first time;
identifying, by the processing circuitry, a second PDCCH transmission received from the gNB device at a second time;
determining, by the processing circuitry, based on the first PDCCH transmission, that the UE device is to transmit a first physical uplink control channel (PUCCH) transmission or a first physical uplink shared control channel (PUSCH) transmission to the gNB device;
determining, by the processing circuitry, based on the second PDCCH transmission, that the UE device is to transmit a second PUCCH transmission or a second PUSCH transmission to the gNB device at a third time overlapping the first PUCCH transmission or the first PUSCH transmission;
setting, by the processing circuitry, a time period after the second PDCCH transmission and during which the UE device is to refrain from transmitting the second PUCCH transmission or the second PUSCH transmission to the gNB device, the time period based on a preparation time for the UE device to generate the second PUSCH transmission after receiving the second PDCCH; and
causing, by the processing circuitry, an antenna of the UE device to transmit the second PUCCH transmission or the second PUSCH transmission to the gNB device after expiration of the time period.

18. The method of claim 17, further comprising:
determining that a first priority of the first PUCCH transmission or the first PUSCH transmission is less than a second priority of the second PUCCH transmission or the second PUSCH transmission,
wherein the UE device transmits the second PUCCH transmission or the second PUSCH transmission to the gNB device and refrains from transmitting at least a portion of the first PUCCH transmission or the first PUSCH transmission based on the first priority and the second priority.

19. The method of claim 17 or claim 18, wherein setting the time period comprises:
determining a value indicative of a capability of the UE device; and
setting the time period based on a sum of the preparation time and the value.

20. The method of claim 19, wherein the time period is longer than the preparation time.

21-25. (canceled)
